(19) United States
(12) Patent Application Publication
(10) Pub. No.: US 2026/0192576 A1
(43) Pub. Date: Jul. 9, 2026

(54) CARD PERSONALIZATION SYSTEM WITH SPLIT PLASMA NOZZLE

(71) Applicant: Entrust Corporation, Shakopee, MN (US)

(72) Inventors: Brett McDONOUGH, Shakopee, MN (US); Michael LIND, Shakopee, MN (US); Cory WOOLDRIDGE, Shakopee, MN (US); Jon WAWRA, Shakopee, MN (US); Ivan LOPEZ ESPINOSA, Shakopee, MN (US); Brendan HINNENKAMP, Shakopee, MN (US)

(21) Appl. No.: 19/441,108

(22) Filed: Jan. 6, 2026

Related U.S. Application Data
(60) Provisional application No. 63/742,701, filed on Jan. 7, 2025.

(51) Int. Cl. B41J 11/00; B41J 3/407; B42D 25/23; B42D 25/24; B42D 25/405; H05H 1/26

(52) U.S. Cl. CPC B41J 11/0021; B41J 3/407; B42D 25/405; H05H 1/26; B42D 25/23; B42D 25/24; H05H 2245/40

(57) ABSTRACT

A split plasma nozzle of a plasma treatment station that is used to plasma treat a surface of a personalized card or other personalized identification document prior to printing. The split plasma nozzle includes a plurality of plasma outlet passages each of which separately outputs plasma stream during plasma treatment of the surface prior to printing. The plasma outlet passages are integrally formed with or in the plasma nozzle whereby the plasma outlet passages and the plasma nozzle are a single-piece, integral, unitary construction with one another.

### PRIORITY

This application claims priority to U.S. Provisional Application No. 63/742,701 filed on Jan. 7, 2025, the entire contents of which are incorporated herein by reference.

### FIELD

This description relates to performing printing operations on surfaces of personalized cards such as financial (e.g., credit, debit, or the like) cards, driver's licenses, national identification cards, business identification cards, and other types of cards which bear or will bear personalized data unique to the cardholder and/or which bear other card information. The printing techniques described herein can also be used to print on passport pages which bear or will bear personalized data unique to the intended passport holder and/or which bear other passport information.

### BACKGROUND

It is known to process personalized cards and other personalized identification documents using various techniques including printing, embossing, reading data from and/or writing data to a magnetic strip, reading data from and/or programming an integrated circuit chip, applying holographic foil patches, and the like. In one known process, printing is performed on a card surface after the card surface has been plasma treated in a plasma treatment station. An example of plasma treating a card surface prior to printing on the card surface is described in U.S. Pat. No. 10,576,769 the entire contents of which are incorporated herein by reference.

### SUMMARY

Apparatus, systems and methods are described where a split plasma nozzle of a plasma treatment station is used to plasma treat a surface of a personalized card or other personalized identification document prior to printing. The plasma treatment of the surface makes the surface more receptive to the printing. The printing can be any type of printing that may benefit from a plasma pre-treatment of the surface. Examples of printing include, but are not limited to, drop-on-demand printing in a drop-on-demand printer that prints using ink, including but not limited to ultra-violet (UV) radiation curable ink.

The personalized identification document can be any type of identification document that bears or will bear personalized data unique to and/or assigned to the intended document holder. Examples of identification documents include, but are not limited to, cards such as financial (e.g., credit, debit, or the like) cards, driver's licenses, national identification cards, business identification cards, and other types of cards which bear or will bear personalized data unique to and/or assigned to the cardholder; and passports and passport pages which bear or will bear personalized data unique to the intended passport holder. The data can be one or more of a portrait image, name, or address of the intended document holder, an account number assigned to the intended document holder, or other data.

In one embodiment, the split plasma nozzle of a plasma treatment station includes a plurality of plasma outlet passages each of which separately outputs plasma during plasma treatment of the surface prior to printing. The plasma outlet passages may be described as being integrally formed with or in the plasma nozzle. The plasma outlet passages and the plasma nozzle may also be described as being a single-piece, integral, unitary construction with one another.

The plasma outlet passages may diverge from one another, and they may be disposed at an acute angle relative to a central axis of the nozzle. In another embodiment, the plasma outlet passages may be parallel to one another, and they may be parallel to the central axis of the nozzle.

The split plasma nozzle described herein covers a larger area of the surface compared to a conventional plasma nozzle with a single plasma outlet, which results in faster processing. In addition, the split plasma nozzle reduces “hot spots” on the surface by reducing the energy per unit area applied to the surface. Further, manufacturing of the plasma nozzle is facilitated because the outlet passages can be formed directly in the body of the plasma nozzle instead of forming separate passages that are then attached to the nozzle.

In one embodiment, a plasma treatment station of a card personalization system can include a transport mechanism that is configured to transport a card through the plasma treatment station, and a plasma nozzle that includes a nozzle body. An ignition chamber is formed in the nozzle body, and at least two plasma outlet passages are formed in the nozzle body and extend from the ignition chamber.

In another embodiment, a card personalization system can include a card input that inputs a card to be printed on; a card output that receives the card after printing; a print station downstream from the card input that is configured to print on a surface of the card; and a plasma treatment station downstream from the card input. The plasma treatment station includes a plasma nozzle where the plasma nozzle includes a nozzle body, an ignition chamber formed in the nozzle body, and at least two plasma outlet passages formed in the nozzle body and extending from the ignition chamber.

In another embodiment, an identification document personalization system can include an identification document input that is configured to input an identification document to be printed on; a print station downstream from the identification document input that is configured to print on a surface of the identification document; and a plasma treatment station downstream from the identification document input. The plasma treatment station includes a plasma nozzle that includes a nozzle body, an ignition chamber formed in the nozzle body, and at least two plasma outlet passages formed in the nozzle body and extending from the ignition chamber.

In another embodiment, a method of forming a plasma nozzle of a card personalization system plasma treatment station includes forming at least two plasma outlet passages in a nozzle body so that the plasma outlet passages extend from an ignition chamber of the nozzle body. The outlet passages can be formed in any suitable manner including, but not limited to, mechanically drilling the outlet passages in the nozzle body, using a laser to generate the outlet passages in the nozzle body, 3D printing of the nozzle including the outlet passages, and other techniques.

### DRAWINGS

FIG. 1 schematically depicts a plasma treatment station of a card personalization system.

FIG. 2 illustrates an example of a personalized identification document in the form of a card.

FIG. 3A is a side cross-sectional view of a plasma nozzle that can be used in the plasma treatment station.

FIG. 3B is an end view of the plasma nozzle of FIG. 3A looking in the direction of the arrow B in FIG. 3A.

FIG. 4A is a side cross-sectional view of another embodiment of a plasma nozzle that can be used in the plasma treatment station.

FIG. 4B is an end view of the plasma nozzle of FIG. 4A looking in the direction of the arrow B in FIG. 4A.

FIG. 5 is a side cross-sectional view of another embodiment of a plasma nozzle that can be used in the plasma treatment station.

FIG. 6 is a schematic illustration of one embodiment of a card personalization system described herein.

FIG. 7 is a schematic illustration of another embodiment of a card personalization system described herein.

FIG. 8 is a schematic illustration of another embodiment of a card personalization system described herein.

FIG. 9 is a schematic illustration of another embodiment of a card personalization system described herein.

### DETAILED DESCRIPTION

As described in further detail below, some or all of a surface of a personalized identification document is plasma treated prior to performing printing on the plasma treated surface in a print mechanism or print station to make the surface more receptive to the printing. The printing can be any type of printing that may benefit from a plasma pre-treatment of the surface. An example of printing includes, but is not limited to, drop-on-demand printing in a drop-on-demand printer that prints using ink, including but not limited to UV curable ink. For sake of convenience, the following description will describe the printing as being drop-on-demand printing in a drop-on-demand printer. However, other types of printing can be utilized.

The personalized identification document can be any type of identification document that bears or will bear personalized data unique and/or assigned to the intended document holder. Examples of identification documents include, but are not limited to, cards such as financial (e.g., credit, debit, or the like) cards, driver's licenses, national identification cards, business identification cards, and other cards which bear or will bear personalized data unique and/or assigned to the cardholder; and passports and passport pages which bear or will bear personalized data unique and/or assigned to the intended passport holder. A financial card, which may also be referred to as a credit card or a debit card, as used herein refers to a type of card that allows the cardholder to borrow funds or that has a stored monetary value. A financial card typically has at least a cardholder name and an account number provided thereon, often by printing. A financial card may also have an integrated circuit chip that stores data relating to the card and/or a magnetic strip that stores data relating to the card and/or a signature panel that allows a user to sign their name and/or a holographic foil patch. The term “personalized identification document” is often used in the personalized card industry to refer to a card or other identification document that already bears personalization and to which additional personalization will be printed, or that does not bear any personalization and to which personalization will be initially applied.

For sake of convenience in describing the concepts herein, the personalized identification document may hereinafter be referred to as a “card”, “plastic card”, or “identification card”. However, the techniques described herein can be applied to other personalized identification documents having one or more surfaces that can be plasma treated to make the surface(s) more receptive to ink.

The card can be a card which may be made entirely of plastic, or a combination of plastic and non-plastic materials. In an embodiment, the card may be made entirely of non-plastic materials such as paper or metal. In an embodiment, the card may be made of a plastic such as polycarbonate, polyvinyl chloride (PVC), polyethylene terephthalate glycol (PETG), and other plastics. In an embodiment, the cards may be ID-1 cards as defined by ISO/IEC 7810. However, other card formats such as ID-2 as defined by ISO/IEC 7810 are possible as well. In an embodiment, the techniques described herein can be used on other identification document substrates such as passports like a front cover page or a rear cover page of the passport, or an internal page (for example a plastic page referred to as a data page) of the passport. In an embodiment, the passports may be in an ID-3 format as defined by ISO/IEC 7810.

The term “personalization” (or the like) as used throughout the specification and claims, unless indicated otherwise, is intended to encompass operations performed on a card (or passport) that includes operations that result in personalizing the card as well as operations that do not result in personalizing the card. An example of a personalization operation that personalizes the card is printing the intended card holder's image or name on the card. An example of a personalization operation that does not personalize the card is printing non-card holder graphics on the card. The term “personalize” is often used in the personalized card industry to refer to a card or other identification document that undergoes both personalization processing operations and non-personalization processing operations.

The concepts described herein can be implemented in any suitable card personalization system. In one embodiment, the card personalization system as a whole, and the plasma treatment and printing techniques described herein, may have a card throughput of at least about 1500 cards per hour. In other embodiments, the card personalization system and the plasma treatment and printing techniques described herein may have a card throughput of at least 2500 cards per hour, and in further embodiments may have a throughput of at least 3000 cards per hour.

One example of a type of card personalization system in which the plasma nozzle described herein can be used is referred to as a central issuance card personalization system that is typically designed for large volume batch processing of cards, often employing multiple processing stations or modules to process multiple cards at the same time to reduce the overall per card processing time. Examples of central issuance card personalization systems include the MX family of central issuance systems available from Entrust Corporation of Shakopee, Minnesota. Other examples of central issuance systems are disclosed in U.S. Pat. Nos. 4,825,054, 5,266,781, 6,783,067, and 6,902,107, all of which are incorporated herein by reference in their entirety.

Another example of a type of card personalization system in which the plasma nozzle described herein can be used is referred to as a desktop card personalization system that is typically designed for relatively small scale, individual card processing. In desktop personalization systems, a single card to be processed is input into the system, processed, and then output. These systems are often termed desktop machines or desktop printers because they have a relatively small footprint intended to permit the machine to reside on a desktop. Many examples of desktop machines are known, such as the SD or CD family of desktop card machines available from Entrust Corporation of Shakopee, Minnesota. Other examples of desktop card personalization systems are disclosed in U.S. Pat. Nos. 7,434,728 and 7,398,972, each of which is incorporated herein by reference in its entirety.

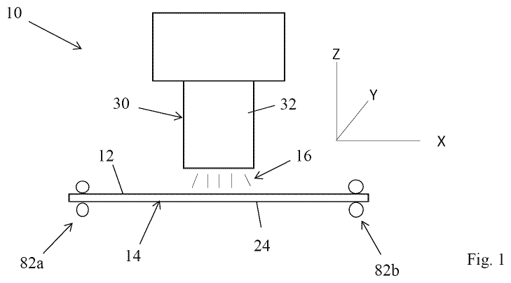

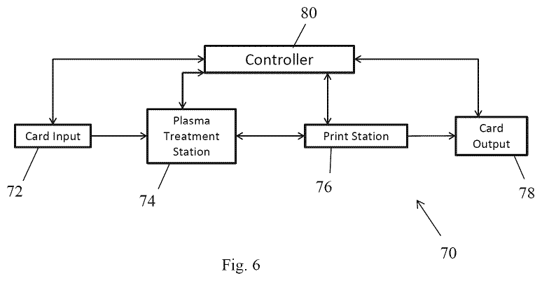

Referring initially to FIG. 1, a plasma treatment station 10 that can be implemented in a card personalization system is illustrated. The plasma treatment station 10 is configured to pre-treat a desired portion of a surface 12 of a card 14 using a stream of ionized gas 16 to render the plasma-treated surface 12 more receptive to a subsequent application of ink that is applied to the plasma-treated surface 12 in a print station (described below in FIGS. 6-9) so that the printed ink adheres better to the surface 12. In one embodiment, the plasma treatment station 10 can include a blown ion plasma system. The general concept of plasma treating a surface of an identification document such as a card is well known in the art.

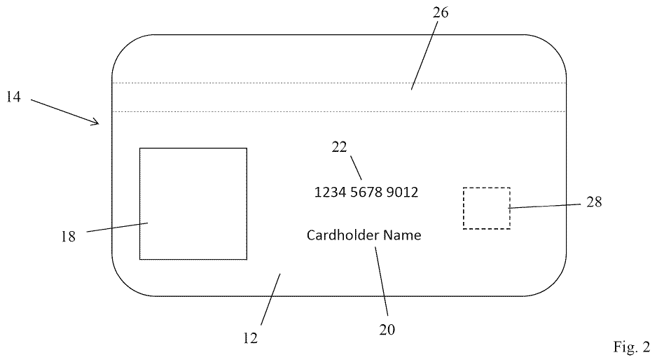

FIG. 2 illustrates an example of the card 14 which may be referred to as a plastic card. The card 14 may be an identification card, a driver's license, a financial card including a credit and debit card, and other personalized cards. The card 14 is depicted as including the surface 12 which may be referred to and considered as a front surface of the card 14. In this example, the surface 12 is the surface that is intended to be printed on. The printing can include a printed image (i.e. a portrait image) 18 of the intended holder of the card 14, where the printed image can be a monochromatic image or a multicolor image for example printed from CMYK pigments, the name 20, address and other personal data of the intended card holder, or a document number such as an account number 22. The card 14 can further include additional personal data provided on the surface 12 and/or provided on an opposite surface 24 (see FIG. 1) such as a CVV number. The additional personal data may be printed onto the card 14 using the same print station described below and/or using other known printing techniques, for example retransfer printing, laser marking, and other printing techniques known in the art of card processing. In the case of the card 14 depicted in FIG. 2, the card 10 may also include a magnetic strip 26 (often disposed on the surface that is opposite the surface 12) that can be magnetically encoded with data. The card 14 may also include an integrated circuit chip 28 that can be electronically programmed with data.

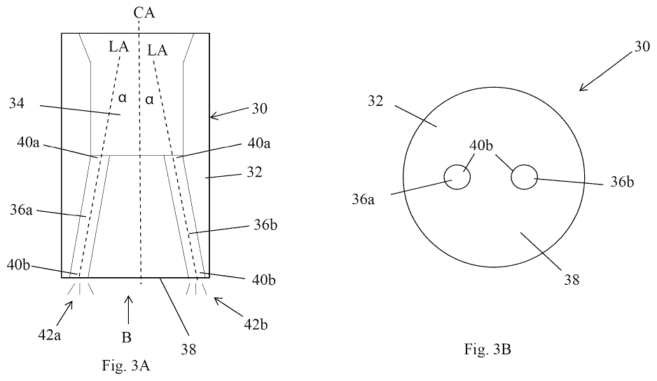

Referring to FIGS. 1 and 3A, 3B, the plasma treatment station 10 includes a plasma nozzle 30. The plasma nozzle 30 includes a nozzle body 32, an ignition chamber 34 formed in the nozzle body 32, and at least two plasma outlet passages 36a, 36b formed in the nozzle body 32. The ignition chamber 34 is configured to generate the ion gas or plasma that is used to treat the surface of the card. The nozzle body 32 includes a card facing surface 38 that in use faces the surface of the card 14 that is being treated. Each one of the plasma outlet passages 36a, 36b includes an inlet end 40a that intersects the ignition chamber 34 and an outlet end 40b that extends through the surface 38. As a result, the passages 36a, 36b extend from the ignition chamber 34 so that plasma generated in the chamber 34 can flow into the passages 36a, 36b and ultimately output toward the card surface in separate streams 42a, 42b.

The passages 36a, 36b may be circular in cross-sectional shape. The passages 36a, 36b may have the same length, shape and diameter. However, in an embodiment, the passages 36a, 36b may have different lengths, shapes and/or diameters. Referring to FIG. 3B, the outlet ends 40b may be circular in shape. However, the outlet ends 40b can have other shapes. In the illustrated example, each one of the passages 36a, 36b has a longitudinal axis LA, and each longitudinal axis LA is disposed at an acute angle α relative to a central axis CA of the nozzle body 32.

With the construction depicted in FIGS. 3A and 3B, the plasma nozzle 30 may be referred to as a split plasma nozzle. The separate passages 36a, 36b with the separate streams 42a, 42b covers a larger area of the card surface compared to a conventional plasma nozzle with a single plasma outlet, which results in faster processing of the card surface. In addition, the separate streams 42a, 42b reduces “hot spots” on the card surface during treatment by reducing the energy per unit area applied to the card surface.

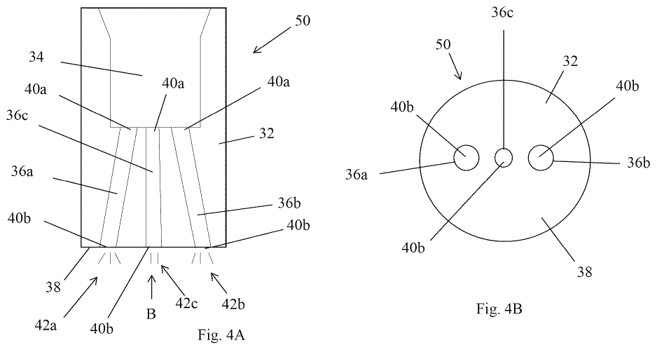

FIGS. 4A and 4B illustrate another embodiment of a plasma nozzle 50 that can be used in the plasma treatment station 10 instead of the plasma nozzle 30. Elements or features in the plasma nozzle 50 that are the same as elements or features in the plasma nozzle 30 are referenced using the same reference numerals. The plasma nozzle 50 includes the nozzle body 32 and the ignition chamber 34 formed in the nozzle body 32. However, in this embodiment, the plasma nozzle 50 is depicted as including three plasma outlet passages 36a, 36b, 36c formed in the nozzle body 32. Each one of the plasma outlet passages 36a, 36b, 36c includes the inlet end 40a that intersects the ignition chamber 34 and the outlet end 40b that extends through the card facing surface 38. As a result, the passages 36a, 36b, 36c extend from the ignition chamber 34 so that plasma generated in the chamber 34 can flow into the passages 36a, 36b, 36c and ultimately output toward the card surface in separate streams 42a, 42b, 42c. As shown in FIG. 4B, the outlet passages 36a, 36b, 36c are arranged relative to each other so that the outlet ends 40b are arranged along a common axis, with the outlet end 40b of the outlet passage 36c between the outlet ends 40b of the outlet passages 36a, 36b. The outlet end 40b of the outlet passage 36c may be equi-distant between the outlet ends 40b of the outlet passages 36a, 36b.

The passages 36a, 36b, 36c may be circular in cross-sectional shape. The passages 36a, 36b may have the same length, shape and diameter. In an embodiment, the passages 36a, 36b may have different lengths, shapes and/or diameters. However, as depicted in FIG. 4B, the outlet end 40b of the outlet passage 36c has an outlet area that is less than an outlet area of the outlet ends 40b of the other two plasma outlet passages 36a, 36b whereby the volume of flow of the stream 42c from the outlet passage 36c may be less than the volume of flow of the streams 42a, 42b. An advantage of this construction is to help achieve a more uniform treatment of the card surface. In another embodiment, the outlet end 40b of the outlet passage 36c can have an outlet area that is the same as or greater than the outlet area of the outlet ends 40b of the other two plasma outlet passages 36a, 36b.

Referring to FIG. 4B, the outlet ends 40b may be circular in shape. However, the outlet ends 40b can have other shapes. In the illustrated example, each one of the passages 36a, 36b has a longitudinal axis that is disposed at an acute angle α relative to a central axis of the nozzle body 32 like with the nozzle 30 in FIG. 3A. The passage 36c is depicted as having a longitudinal axis that is on the central axis of the nozzle body 32. Therefore, the longitudinal axis of the passage 36c and the longitudinal axes of the passages 36a, 36b are disposed at an acute angle α relative to one another.

With the construction depicted in FIGS. 4A and 4B, the plasma nozzle 50 may be referred to as a split plasma nozzle. The separate passages 36a, 36b, 36c with the separate streams 42a, 42b, 42c covers a larger area of the card surface compared to a conventional plasma nozzle with a single plasma outlet, which results in faster processing of the card surface. In addition, the separate streams 42a, 42b, 42c reduces “hot spots” on the card surface during treatment by reducing the energy per unit area applied to the card surface.

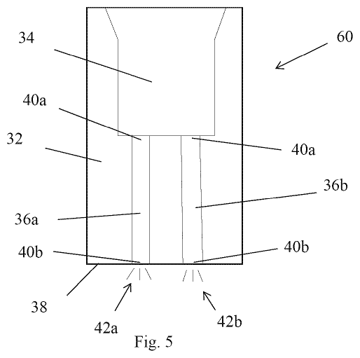

FIG. 5 illustrates another embodiment of a plasma nozzle 60 that can be used in the plasma treatment station 10 instead of the plasma nozzle 30. Elements or features in the plasma nozzle 60 that are the same as elements or features in the plasma nozzle 30 are referenced using the same reference numerals. The plasma nozzle 60 includes the nozzle body 32 and the ignition chamber 34 formed in the nozzle body 32. However, in this embodiment, the plasma nozzle 60 is depicted as including two plasma outlet passages 36a, 36b formed in the nozzle body 32 where the longitudinal axes of the outlet passages 36a, 36b are parallel to one another and parallel to the central axis of the nozzle body 32.

In the nozzle 60, each one of the plasma outlet passages 36a, 36b includes the inlet end 40a that intersects the ignition chamber 34 and the outlet end 40b that extends through the card facing surface 38. As a result, the passages 36a, 36b extend from the ignition chamber 34 so that plasma generated in the chamber 34 can flow into the passages 36a, 36b and ultimately output toward the card surface in separate streams 42a, 42b. The passages 36a, 36b may be circular in cross-sectional shape. The passages 36a, 36b may have the same length, shape and diameter. However, in an embodiment, the passages 36a, 36b may have different lengths, shapes and/or diameters. In an end view looking toward the card facing surface 38, the outlet ends 40b may be circular in shape similar to FIG. 3B. However, the outlet ends 40b can have other shapes.

Manufacturing of the plasma nozzles described herein is facilitated because the outlet passages can be formed directly in the body of the plasma nozzle. For example, because the outlet passages are linear and extend from the ignition chamber, the outlet passages can be formed using conventional manufacturing techniques including, but not limited to, mechanically drilling the outlet passages in the nozzle body, using a laser to generate the outlet passages in the nozzle body, 3D printing of the nozzle including the outlet passages, and other manufacturing techniques. The plasma outlet passages are integrally formed with or in the plasma nozzle. The plasma outlet passages and the plasma nozzle are also a single-piece, integral, unitary construction with one another.

In one embodiment, the total output area of the outlet ends 40b (for both two outlet passages and three outlet passages) can be less than the total output area of a conventional plasma nozzle with a single plasma outlet passage. In another embodiment, the total output area of the outlet ends 40b (for both the two outlet passages and three outlet passages) can be substantially equal to the total output area of a conventional plasma nozzle with a single plasma outlet passage. In an embodiment, the total output flow of the streams from the outlet ends 40b can range from 40-120 m/s. In another embodiment, the total output flow of the streams from the outlet ends 40b can range from 60-100 m/s. In another embodiment, the total output flow of the streams from the outlet ends 40b can range from 70-100 m/s, or from 80-100 m/s. In another embodiment, the total output flow of the streams from the outlet ends 40b can range from 60-90 m/s or 60-80 m/s.

Returning to FIG. 1, the plasma nozzle 30 has a plasma discharge width that is less than the width of the card. Therefore, during plasma treatment of the card surface 12, the plasma nozzle 30 and the card 14 may be movable relative to one another to allow treatment of the desired area(s) of the surface 12. For example, the plasma nozzle 30 may be movable in an X-Y plane (the X direction being parallel to the card length direction and the Y direction being parallel to the card width) relative to the card. In another embodiment, the card can be moved in an X-Y plane relative to the plasma nozzle 30. The plasma nozzle 30 and the card 14 may also be movable toward and away from one another in the Z-axis direction to change the distance therebetween. Further information on moving a plasma nozzle and a card relative to one another during plasma treatment is described in U.S. Pat. No. 10,576,769 the entire contents of which are incorporated herein by reference.

FIG. 6 illustrates an example of one embodiment of a card/identification document personalization system 70 that can be used to plasma treat and print on cards 12 (FIGS. 1 and 2) such as plastic cards as described herein. In this example, the system 70 can include a card/identification document input 72, a plasma treatment station 74 that can have a construction like the plasma treatment station 10 described above, a print station 76 such as a drop-on-demand print station, and a card output 78. The elements 72-78 in the system 70 can be part of a central issuance card/identification document processing system or part of a desktop card/identification document processing system. The elements 72-78 can be separate stations or modules, or the functionalities of one or more of the elements 72-78 can be combined into what may be considered a common station or module with the other elements. For example, the plasma treatment station 74 and the print station 76 could be combined into what may be considered a common station instead of being separate stations as implied in FIG. 6. A controller 80 is connected to and controls the operation of each of the elements 72-78.

The card input 72 can be an input hopper designed to hold a plurality of cards/identification documents waiting to be fed on-by-one into the system 70 for processing. An example of an input hopper in the form of a card input hopper is described in U.S. Pat. No. 6,902,107 which is incorporated herein by reference in its entirety. Alternatively, the card input 72 can be an input slot through which individual cards are fed one-by-one into the system 70.

The plasma treatment station 74 can be configured like the plasma treatment station 10 described above to pre-treat a desired portion of the surface of the card using a stream of ionized gas to render the plasma-treated surface more receptive to the subsequent application of ink that is applied to the plasma-treated surface in the print station 76 so that the printed ink adheres better to the surface. In one embodiment, the plasma treatment station 74 can include a blown ion plasma system. The general concept of plasma treating a surface of a card or other identification document is well known in the art. In an embodiment, the plasma nozzle can be controlled to move relative to the card surface in order to allow treatment of the entire card surface. In one example, the plasma nozzle can move in a serpentine pattern relative to the card surface as described in U.S. Pat. No. 10,576,769 the entire contents of which are incorporated herein by reference.

The print station 76 can be configured to perform any type of printing on the card surface after being plasma treated, where the printing can benefit from the plasma treatment. In one embodiment, the print station 76 can be configured to perform drop-on-demand printing, where the print station 76 includes at least one drop-on-demand print head that performs drop-on-demand printing using a suitable ink. In another non-limiting embodiment, the print station 76 may be configured to print on the card surface using thermal printing via a thermal print head and a thermal print ribbon.

The card output 78 can be a card output hopper designed to hold a plurality of processed cards that are output one-by-one after being processed within the system 70. An example of a card output hopper is described in U.S. Pat. No. 6,902,107 which is incorporated herein by reference in its entirety. Alternatively, the card output 78 can be an output slot through which individual cards are output one-by-one. In the case of central issuance card processing systems, the card output 78 can be the last element in the system 70 and located at the downstream end of the system 70. However, the card output 20 is not required in a central issuance card processing system and the processed cards can be output directly to an inserter mechanism that attaches the cards to card carrier forms to create card/carrier combinations, folds the card/carrier combinations and inserts the card carrier combinations into envelopes for mailing to the intended recipients. In the case of desktop card processing systems, the card output 78 can be located at the downstream end of the system 70 in some systems, or even located at the same end of the system 70 as the card input 72.

A card/identification document transport system is provided that transports the card along a card travel path between the card input 72, the plasma treatment station 74, the print station 76 and the card output 78. The card transport system can have any construction suitable for transporting the card. Many examples of card transport systems that could be used are well known in the art. Examples of card transport systems that can be used include, but are not limited to, rollers, belts (with tabs or without tabs), carriage(s), any combinations thereof, and the like. The construction and operation of card transport systems for transporting cards between a card input, a card output, and card processing stations between a card input and a card output are well known in the art. FIG. 1 illustrates the plasma treatment station 10 as including a card transport mechanism in the form of first and second sets of rollers 82a, 82b that transport the card 14 with the surface 12 facing upward, for example facing toward the nozzle 30.

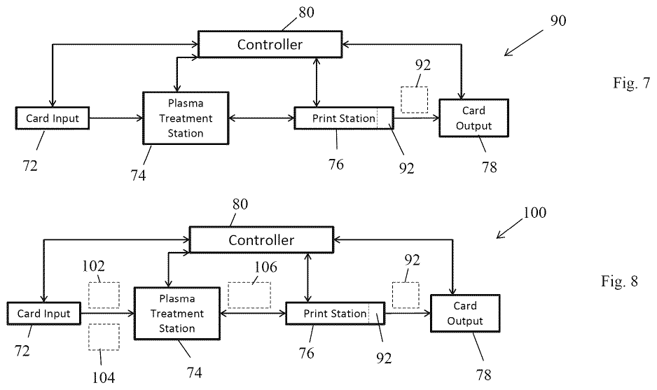

FIG. 7 illustrates another example of a card/identification document personalization system 90 that can be used to plasma treat and print on cards 12 (FIGS. 1 and 2) such as plastic cards as described herein. In this example, elements/features that are the same as elements/features in FIG. 6 are referenced using the same reference numerals. The system 90 is shown as including the card/identification document input 72, the plasma treatment station 74, the print station 76, the card output 78, and the controller 80. In the system 90, the ink used by the print station 76 is radiation curable ink, such as UV curable ink, that is cured by exposing the applied ink to a curing radiation, such as UV radiation. The print station 76 may be configured to perform drop-on-demand printing, or may be configured as a thermal printer that prints radiation curable ink from a print ribbon as described in U.S. Pat. No. 10,889,129 the entire contents of which are incorporated herein by reference. The system 90 further includes a radiation applicator 92 that can be included in the print station 76 or separate from the print station 76 (indicated in dashed lines in FIG. 7) to apply radiation to cure the radiation curable ink or other material after the radiation curable ink or material is applied. The radiation applicator 92 can be configured to apply UV radiation. An example of a drop-on-demand printer and a UV radiation applicator in a card printing system is the Persomaster card personalization system available from Atlantic Zeiser GmbH of Emmingen, Germany.

FIG. 8 illustrates another example of a card/identification document personalization system 100 that can be used to plasma treat and print on cards 12 (FIGS. 1 and 2) such as plastic cards as described herein. In this example, elements/features that are the same as elements/features in FIGS. 6 and 7 are referenced using the same reference numerals. The system 100 is shown as including the card/identification document input 72, the plasma treatment station 74, the print station 76, the card output 78, the controller 80, and the radiation applicator 92. The system 100 further includes an integrated circuit chip programming station 102 and/or a magnetic strip encoding station 104. The stations 102, 104 may be located anywhere in the system 100. For example, FIG. 8 depicts the stations 102, 104 between the card input 72 and the plasma treatment station 74. However, the stations 102, 104 can be at other locations in the system 100. The integrated circuit chip programming station 102, if present, is configured to program the integrated circuit chip 28 on the card 12 (see FIG. 2). The station 102, if present, may be configured to program a single chip of a single card, or the station may be considered to simultaneously program the chips on multiple cards. The magnetic strip encoding station 104, if present, is configured to magnetically read data from and/or magnetically data onto the magnetic strip 26 on the card 12 (see FIG. 2).

FIG. 8 also depicts that the system 100 may also optionally include a card reorienting mechanism 106 (or card flipper). The mechanism 106 can be configured to rotate the card 180 degrees so that a surface initially facing upward (or facing to one side) now faces downward (or faces toward the opposite side). The mechanism 106 is useful in embodiments where plasma treatment and printing are desired on each of the top and bottom (or front and back) surfaces of the card in which case the plasma treatment and the printing on each of the card surfaces can be performed using the single plasma treatment station and the single print station. In some embodiments, the mechanism 106 can be positioned as depicted in FIG. 8 between the plasma treatment station 74 and the print station 76. However, the mechanism 106 can be located elsewhere in the system 100.

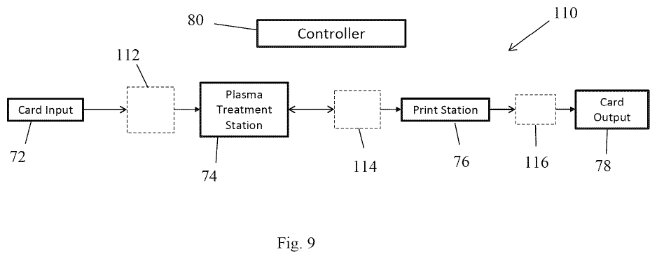

FIG. 9 illustrates another example of a card/identification document personalization system 110 that can be used to plasma treat and print on cards 12 (FIGS. 1 and 2) such as plastic cards as described herein. In this example, elements/features that are the same as elements/features in FIGS. 6 and 7 are referenced using the same reference numerals. The system 110 is shown as including the card/identification document input 72, the plasma treatment station 74, the print station 76, the card output 78, and the controller 80. The system 110 is also shown as optionally including one or more card processing mechanisms 112 between the card input 72 and the plasma treatment station 74, one or more optional card processing mechanisms 114 between the plasma treatment station 74 and the print station 76, and one or more optional card processing mechanisms 116 between the print station 76 and the card output 78. The optional mechanism(s) 112 can include, but are not limited to, one or more of: an integrated circuit chip programming mechanism; a magnetic strip encoding mechanism; an embossing mechanism; an indenting mechanism; a laminating mechanism; a laser marking mechanism; a topcoat applicator; a security station that is configured to apply a security feature such as a holographic foil patch to the card; a flipping mechanism to flip the card 180 degrees; and other card processing mechanisms. The optional mechanism(s) 114 can include, but are not limited to, one or more of: an integrated circuit chip programming mechanism; a magnetic strip encoding mechanism; an embossing mechanism; an indenting mechanism; a laminating mechanism; a laser marking mechanism; a topcoat applicator; a security station that is configured to apply a security feature such as a holographic foil patch to the card; a flipping mechanism to flip the card 180 degrees; and other card processing mechanisms. The optional mechanism(s) 116 can include, but are not limited to, one or more of: an integrated circuit chip programming mechanism; a magnetic strip encoding mechanism; an embossing mechanism; an indenting mechanism; a laminating mechanism; a laser marking mechanism; a topcoat applicator; a security station that is configured to apply a security feature such as a holographic foil patch to the card; a flipping mechanism to flip the card 180 degrees; and other card processing mechanisms.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A card personalization system, comprising:
a card input that inputs a card to be printed on;
a card output that receives the card after printing;
a print station downstream from the card input, the print station is configured to print on a surface of the card;
a plasma treatment station downstream from the card input, the plasma treatment station includes a plasma nozzle; and
the plasma nozzle includes a nozzle body, an ignition chamber formed in the nozzle body, and at least two plasma outlet passages formed in the nozzle body and extending from the ignition chamber.

2. The card personalization system of claim 1, wherein the card input is located at a first end of the card personalization system, the card output is located at a second end of the card personalization system, and the print station and the plasma treatment station are located between the card input and the card output.

3. The card personalization system of claim 1, wherein each one of the at least two plasma outlet passages has a longitudinal axis, and each longitudinal axis is disposed at an acute angle relative to a central axis of the nozzle body.

4. The card personalization system of claim 1, comprising three of the plasma outlet passages formed in the nozzle body and extending from the ignition chamber.

5. The card personalization system of claim 4, wherein one of the three plasma outlet passages is located between the other two plasma outlet passages, and the one plasma outlet passage has an outlet area that is less than an outlet area of the other two plasma outlet passages.

6. The card personalization system of claim 1, wherein the print station includes at least one drop-on-demand print head.

7. The card personalization system of claim 1, further comprising a radiation curing mechanism that is configured to receive the card and emit curing radiation toward the surface.

8. The card personalization system of claim 1, wherein the plasma treatment station is located between the card input and the print station.

9. An identification document personalization system, comprising:
an identification document input that is configured to input an identification document to be printed on;
a print station downstream from the identification document input, the print station is configured to print on a surface of the identification document;
a plasma treatment station downstream from the identification document input, the plasma treatment station includes a plasma nozzle; and
the plasma nozzle includes a nozzle body, an ignition chamber formed in the nozzle body, and at least two plasma outlet passages formed in the nozzle body and extending from the ignition chamber.

10. The identification document personalization system of claim 9, wherein the identification document input is located at a first end of the card personalization system, and the plasma treatment station is located between the card input and the print station.

11. The identification document personalization system of claim 9, wherein each one of the at least two plasma outlet passages has a longitudinal axis, and each longitudinal axis is disposed at an acute angle relative to a central axis of the nozzle body.

12. The identification document personalization system of claim 9, comprising three of the plasma outlet passages formed in the nozzle body and extending from the ignition chamber.

13. The identification document personalization system of claim 12, wherein one of the three plasma outlet passages is located between the other two plasma outlet passages, and the one plasma outlet passage has an outlet area that is less than an outlet area of the other two plasma outlet passages.

14. The identification document personalization system of claim 9, wherein the print station includes at least one drop-on-demand print head.

15. The identification document personalization system of claim 9, further comprising a radiation curing mechanism that is configured to receive the card and emit curing radiation toward the surface.

16. A plasma treatment station of a card personalization system, comprising:
a transport mechanism that is configured to transport a card through the plasma treatment station;
a plasma nozzle that includes a nozzle body, an ignition chamber formed in the nozzle body, and at least two plasma outlet passages formed in the nozzle body and extending from the ignition chamber.

17. The plasma treatment station of claim 16, wherein the transport mechanism is configured to transport the card with a surface of the card facing upward.
